(19) United States
(12) Patent Application Publication
(10) Pub. No.: US 2011/0066836 A1
(43) Pub. Date: Mar. 17, 2011

(54) OPERATING SYSTEM BOOTING METHOD, COMPUTER, AND COMPUTER PROGRAM PRODUCT

(75) Inventors: Akira Iguchi, Kanagawa (JP); Kenichi Nagai, Tokyo (JP); Konosuke Watanabe, Kanagawa (JP); Ken Kawakami, Kanagawa (JP); Jiro Amemiya, Tokyo (JP)

(73) Assignee: Kabushiki Kaisha Toshiba, Tokyo (JP)

(21) Appl. No.: 12/876,452

(22) Filed: Sep. 7, 2010

(30) Foreign Application Priority Data
Sep. 14, 2009 (JP) 2009-212288

(51) Int. Cl. G06F 15/177

(52) U.S. Cl. 713/2

(57) ABSTRACT

According to one embodiment, a CPU boots a small OS having a function of executing a target application, boots the target application on the booted small OS, and boots a CPU dispatcher for switching an execution OS. The CPU boots a rich OS capable of executing applications larger in number than applications executed by the small OS by using the CPU dispatcher, in a background of the small OS, while causing the target application booted on the small OS to run. After the rich OS is booted, the CPU boots the target application on the booted OS separately from the target application running on the small OS. The CPU passes an execution state of the target application running on the small OS to the target application booted on the rich OS and shifting the execution OS from the small OS to the rich OS.

### CROSS-REFERENCE TO RELATED APPLICATIONS

This application is based upon and claims the benefit of priority from the prior Japanese Patent Application No. 2009-212288, filed on Sep. 14, 2009; the entire contents of which are incorporated herein by reference.

### FIELD

Embodiments described herein relate generally to an operating system booting method, a computer, and a computer program product.

### BACKGROUND

Concerning a computer such as a mobile terminal, there is a demand that time required for enabling the use of an application after the booting of the computer should be reduced as much as possible.

For example, according to Japanese Patent Application Laid-Open No. 2003-196096, at an initial stage when hardware is booted, a small operating system (OS) (or a general-purpose OS) is booted and, after the general-purpose OS is booted, the small OS is stored in a free-use memory area, whereby an OS in use (an execution OS) is shifted. By booting the small OS first using this technology, it is possible to reduce time required for enabling a user to use an application running on the small OS after a computer is booted. However, according to this technology, when the small OS is shifted to a general-purpose OS of a full specification (a rich OS), operation for suspending and resuming a CPU is necessary. In suspending and resuming the CPU, the user needs to suspend the use of the computer. As a result, convenience for the user is sacrificed in exchange for an increase in speed of the booting.

### BRIEF DESCRIPTION OF THE DRAWINGS

FIG. 1 is a diagram of the configuration of a computer according to an embodiment of the present invention;

FIGS. 2A and 2B are diagrams for explaining a display screen;

FIG. 3 is a flowchart for explaining an operating system booting method according to the embodiment;

FIGS. 4A to 4D are diagrams for explaining states of the computer;

FIG. 5 is a flowchart for explaining operation performed when an exception occurs; and

FIG. 6 is a timing chart for explaining takeover processing.

### DETAILED DESCRIPTION

In general, according to one embodiment, a CPU boots a small OS having a function of executing a target application, boots the target application on the booted small OS, and boots a CPU dispatcher for switching an execution OS. The CPU boots a rich OS capable of executing applications larger in number than applications executed by the small OS by using the CPU dispatcher, in a background of the small OS, while causing the target application booted on the small OS to run. After the rich OS is booted, the CPU boots the target application on the booted OS separately from the target application running on the small OS. The CPU passes an execution state of the target application running on the small OS to the target application booted on the rich OS and shifting the execution OS from the small OS to the rich OS.

Exemplary embodiments of an operating system booting method, a computer, and a computer program product will be explained below in detail with reference to the accompanying drawings. The present invention is not limited to the following embodiments.

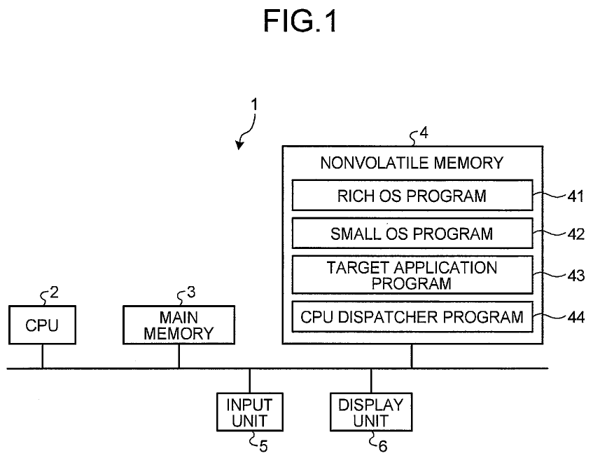

FIG. 1 is a block diagram of an example of a hardware configuration of a computer that executes an operating system booting method according to an embodiment of the present invention.

As shown in the figure, a computer 1 according to this embodiment includes a central processing unit (CPU) 2, a main memory 3, a nonvolatile memory 4, an input unit 5, and a display unit 6. The CPU 2, the main memory 3, the nonvolatile memory 4, the input unit 5, and the display unit 6 are connected to one another by a bus.

The nonvolatile memory 4 includes a read only memory (ROM) or a flash memory. The nonvolatile memory 4 has stored therein a rich operating system (OS) program 41, a small OS program 42, a target application program 43, and a CPU dispatcher program 44.

The rich OS program 41 is a computer program of an OS that can cause the computer 1 to execute an application group for realizing various functions. In other words, the rich OS program 41 is an OS which has a full specification.

The target application program 43 is a program of an application desired to be usable in a short time from the start of the booting of the computer 1 (hereinafter, “target application”). The target application can be any application. For example, when a function of browsing the Internet is regarded as important and it is desired to make the function usable as soon as possible, it is advisable to set an application for performing the browsing of the Internet as the target application. Besides, it is advisable to set a desired application such as an application for editing a text file, an application for editing a presentation material, or an application for browsing and transmitting and receiving an electronic mail as the target application according to a function regarded as important. A plurality of the target applications can be present.

The small OS program 42 is a computer program of an OS having a function necessary for executing at least the target application program 43 and is small in size compared with the rich OS program 41. Because the small OS program 42 is small in size compared with the rich OS program 41, the small OS program 42 can be booted faster than the rich OS program 41. In this embodiment, first, the small OS program 42 is booted and the target application program 43 is booted on the booted small OS program 42, whereby time required for enabling the use of the target application program 43 from the start of the booting of the computer 1 is reduced. To further reduce the time required for enabling the use of the target application program 43 from the start of the booting of the computer 1, it is desirable to set only the target application as an application executable by the small OS program 42 and limit functions of the small OS program 42 to necessary minimum functions.

The CPU dispatcher program 44 is a computer program for switching an OS executed by the CPU 2 among a plurality of OSs. Specifically, the switching of the OS includes saving and restoration of a register and switching of an address space used by two switching target OSs. In this embodiment, the CPU dispatcher program 44 is booted after the booting of the small OS program 42. The rich OS program 41 is booted in the background of the small OS program 42 by using the CPU dispatcher program 44. Specifically, the booted CPU dispatcher program 44 switches the allocation of the CPU 2 between the small OS program 42 for causing the target application program 43 to run and the rich OS program 41 after the start of the booting. The CPU dispatcher program 44 allocates the CPU 2 more preferentially to the small OS program 42 than the rich OS program 41.

As explained in detail later, after the booting of the rich OS program 41 is completed, the target application program 43 is booted on the rich OS program 41. After the booting of the target application program 43 on the rich OS program 41 is completed, the small OS program 42 and the CPU dispatcher program 44 are stopped. A user can use not only the target application but also all applications running on the rich OS program 41.

The main memory 3 is composed of a random access memory (RAM) and so on. The main memory 3 can be accessed at high speed compared with the nonvolatile memory 4. The main memory 3 is used as a work area for the CPU 2 to execute the computer programs 41 to 44 stored in the nonvolatile memory 4. Specifically, the CPU 2 loads program images (hereinafter also referred to as, “memory images”) of the computer programs 41 to 44.

The user operates the target application, whereby an execution state of the target application changes every moment. To switch control from the target application executed on the small OS program 42 to the target application booted on the rich OS program 41 without making the user aware that the OS is shifted, the target application running on the small OS program 42 creates various data necessary for reproducing an execution state of the target application (hereinafter, “takeover data”). The created takeover data is stored on the main memory 3 and passed to the target application booted on the rich OS program 41.

The input unit 5 includes a mouse and a keyboard. Operation concerning applications including the target application from the user is input. Information concerning the operation input to the input unit 5 is sent to the CPU 2.

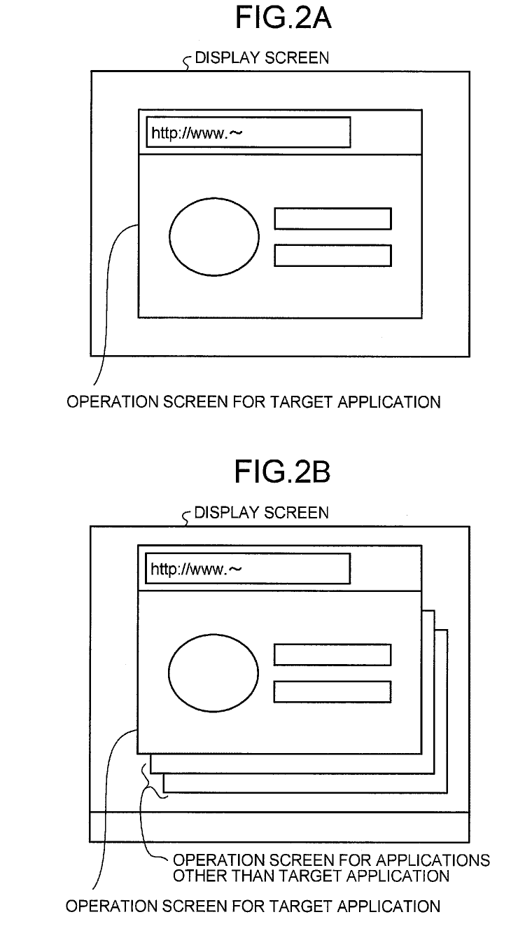

The display unit 6 is a display device such as a liquid crystal monitor. The display unit 6 displays, based on an instruction from the CPU 2, information concerning output to the user such as an operation screen for an application. In this embodiment, the operation screen for the target application is displayed on a display screen of the display unit 6 as shown in FIG. 2A until the small OS program 42 is finished. When the booting of the rich OS program 41 and the target application on the rich OS program 41 is completed and the small OS program 42 is finished, not only the operation screen for the target application but also operation screens for other applications are displayed as shown in FIG. 2B.

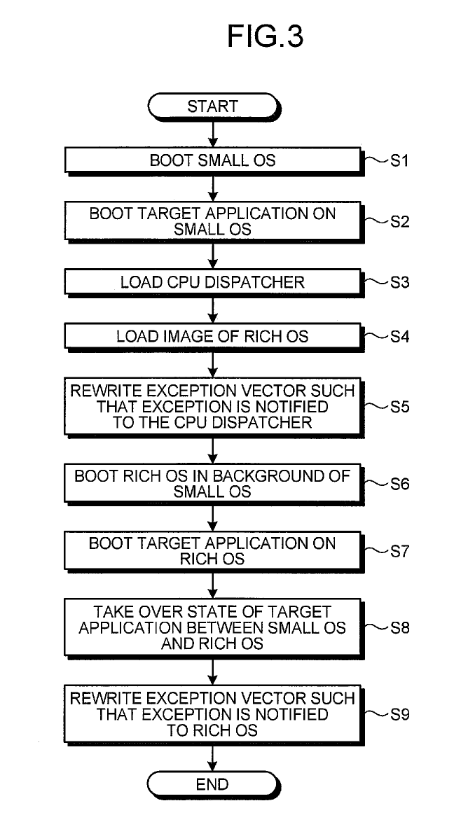

An operating system booting method according to this embodiment executed in the computer 1 is explained with reference to FIGS. 3 to 6. FIG. 3 is a flowchart for explaining the operating system booting method according to this embodiment. In the following explanation, in some case, the rich OS program 41 is simply represented as rich OS 41. Similarly, in some case, the small OS program 42, the target application program 43, and the CPU dispatcher program 44 are respectively represented as small OS 42, target application 43, and CPU dispatcher 44.

As shown in FIG. 3, when the booting of the computer 1 is started, first, the CPU 2 reads out the small OS 42 from the nonvolatile memory 4, loads the read-out small OS 42 to the main memory 3, and boots the small OS 42 (step S1). For the booting of the small OS 42, snapshot boot can be used to execute the booting at higher speed. The snapshot boot is operation for recording a memory image immediately after the booting of an OS in the nonvolatile memory 4 or the like and expanding the memory image directly on the main memory 3 during the booting to realize high-speed booting (e.g., Japanese Patent Application No. 2008-107966). The size of the memory image tends to increase according to an increase in the size of an OS program and booting time tends to be long according to the increase in the size of the memory image. As explained above, the small OS 42 is a relatively-small computer program that only has to have, concerning applications, the function for executing the target application 43. Therefore, an increase in speed of the booting of the small OS 42 can be expected by using the snapshot boot.

Subsequently, when the booting of the small OS 42 is completed, the CPU 2 boots the target application 43 on the booted small OS 42 (step S2). When the booting of the target application 43 is completed, as shown in FIG. 2A, the CPU 2 causes the display unit 6 to display an operation screen for the target application 43 on the display screen of the display unit 6. In this way, the small OS 42 is booted instead of the rich OS 41 of the full specification and the target application 43 is booted on the small OS 42. Therefore, the user can use the target application 43 in a short time compared with time for booting the rich OS 41 and booting the target application 43 on the rich OS 41.

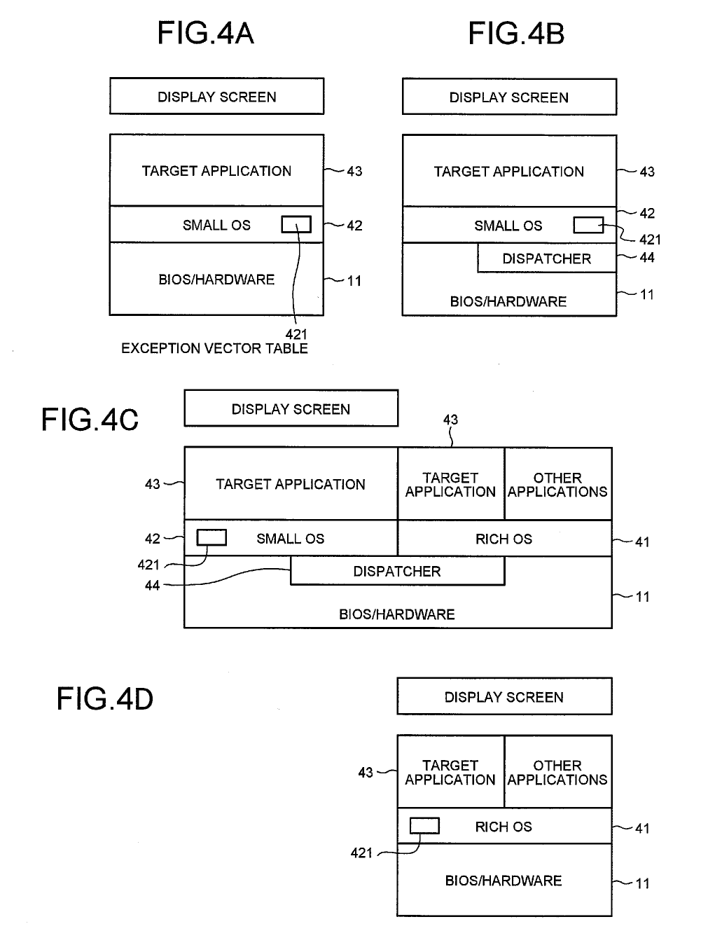

FIGS. 4A to 4D are conceptual diagrams for explaining states of the computer 1 that are changed by the operating system booting method according to this embodiment. FIG. 4A is a diagram for explaining a state of the computer 1 in which the target application 43 is booted at step S2. As shown in the figure, the small OS 42 is running on hardware 11. The target application 43 is running on the small OS 42. The hardware 11 includes a basic input-output system (BIOS) (in the figure, referred to as BIOS/hardware). The display screen displays the operation screen for the target application 43. In the small OS 42, for each of types of exceptions and interrupts (hereinafter collectively referred to as “exceptions”), an exception vector address (hereinafter simply referred to as “exception vector”) as an address on a memory space of a computer program corresponding to the type is defined. The small OS 42 has, in a kernel area of the memory space, an exception vector table 421 indicating the exception vector for each of the types of the exceptions. At this point, the exception vector of the exception vector table 421 indicates a storage location of the computer program included in the small OS 42. An exception is, for example, an input from the input unit 5 for operating the target application by the user.

Referring back to FIG. 3, after completing the booting of the target application 43 on the small OS 42, the CPU 2 reads out the CPU dispatcher 44 from the nonvolatile memory 4, loads the read-out CPU dispatcher 44 to the main memory 3, and boots the CPU dispatcher 44 (step S3).

FIG. 4B shows a state immediately after the CPU dispatcher 44 is booted. As shown in the figure, the CPU dispatcher 44 (in the figure, simply referred to as dispatcher 44) is intervened between the hardware 11 and the small OS 42. When an exception occurs at this point, the CPU 2 notifies, based on the exception vector table 421 included in the small OS 42, the small OS 42 of the exception.

After step S3, the CPU 2 reads out the rich OS 41 from the nonvolatile memory 4 and loads the read-out rich OS 41 to the main memory 3 (step S4).

To boot the rich OS 41 in the background of the small OS 42, the CPU 2 rewrites the exception vector table 421 and sets an entry point of the CPU dispatcher 44 in the exception vector (step S5). The CPU 2 starts the booting of the rich OS 41 in the background of the small OS 42 using the CPU dispatcher 44 (step S6). The snapshot boot can also be applied to the booting of the rich OS 41.

“Processing concerning the rich OS 41 such as the booting of the rich OS 41 is executed in the background of the small OS 42” specifically means that the processing concerning the rich OS 41 is executed while the small OS 42 is idle. When neither operation by the user concerning the target application 43 on the small OS 42 is not executing nor the target application 43 is not executing processing, the CPU dispatcher 44 switches control from the small OS 42 to the rich OS 41 that is booting itself or booting the target application 43. When an exception concerning the small OS 42 such as an input concerning the target application 43 from the user occurs, the CPU dispatcher 44 switches the control from the rich OS 41 to the small OS 42.

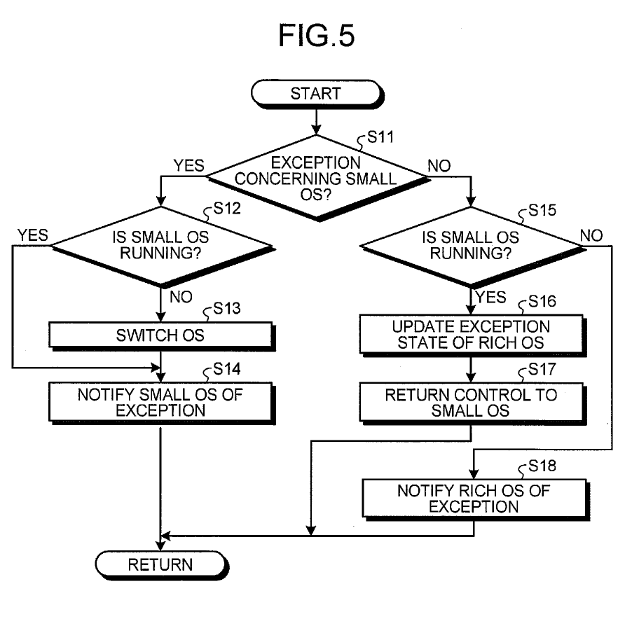

FIG. 5 is a flowchart for explaining the operation of the CPU dispatcher 44 performed when an exception occurs. As shown in the figure, when an exception occurs, the CPU 2 switches the control to the CPU dispatcher 44 referring to the exception vector table 421 and determines whether the occurred exception is an exception concerning the small OS 42 (step S11). When the occurred exception is an exception concerning the small OS 42 (“Yes” at step S11), the CPU 2 further determines whether the small OS 42 is running (step S12). When the rich OS 41 is running (“No” at step S12), the CPU dispatcher 44 changes allocation of the CPU 2 from the rich OS 41 to the small OS 42, i.e., switches an OS (step S13) and notifies the small OS 42 of the occurred exception (step S14). When the notification of the exception ends, the CPU 2 switches the control from the CPU dispatcher 44 to the small OS 42. The operation of the CPU dispatcher 44 returns to the start. When the CPU 2 determines at step S12 that the small OS 42 is running (“Yes” at step S12), the operation shifts to step S14.

On the other hand, when the CPU 2 determines at step S11 that the occurred exception is an exception concerning the rich OS 41 (“No” at step S11), the CPU 2 further determines whether the small OS 42 is running (step S15). When the small OS 42 is running (“Yes” at step S15), the CPU dispatcher 44 records an exception state of the rich OS 41 in the CPU dispatcher 44 to delay an exception notification to the rich OS 41 until the small OS 42 becomes idle (step S16). The CPU 2 switches the control from the CPU dispatcher 44 to the small OS 42 (returns the control to the small OS 42) (step S17). The operation of the CPU dispatcher 44 returns to the start. The exception state of the rich OS 41 recorded at step S16 is thereafter referred to when the small OS 42 becomes idle and the control is switches to the rich OS 41. When the exception state is recorded, the exception is notified from the CPU dispatcher 44 to the rich OS 41.

When the CPU 2 determines at step S15 that the rich OS 41 is running (“No” at step S15), the CPU dispatcher 44 notifies the rich OS 41 of the exception (step S18). The operation of the CPU dispatcher 44 returns to the start.

In this way, when the small OS 42 is in the idle state, the CPU dispatcher 44 allocates the CPU 2 to the rich OS 41. When an exception occurs while the CPU 2 is executing processing concerning the rich OS 41 (booting of the rich OS 41 or booting of the target application 43 on the rich OS 41 explained later), the CPU 2 switches the control to the CPU dispatcher 44 based on a description of the exception vector table 421. The CPU dispatcher 44 allocates, based on the CPU dispatcher 44, the CPU 2 to the small OS 42. Specifically, the CPU dispatcher 44 allocates the CPU 2 to the small OS 42 more preferentially than the rich OS 41.

In this embodiment, it is advisable to allow both the small OS 42 and the rich OS 41 to directly control devices. In this case, device drivers of the OSs 41 and 42 need to operate, in cooperation with each other, devices (e.g., the input unit 5 and the display unit 6) shared by the OSs 41 and 42. For example, when the device driver of the rich OS 41 booted anew performs device detection, if already initialized, the device driver issues a request to the device driver of the small OS 42 to indirectly operate the device without being initialized. When the small OS 42 is changed to be not used at step S9 explained later, it is advisable to notify the drivers having the shared devices to that effect to make it possible to change the processing such that only the rich OS 41 directly operates the devices.

Referring back to FIG. 3, the CPU 2 boots the target application 43 on the rich OS 41 after the end of the booting of the rich OS 41 (step S7). Because this processing is also executed in the background of the small OS 42, the user can see only the target application 43 on the small OS 42. At step S7, the CPU 2 can boot not only the target application 43 but also applications other than the target application 43 running on the rich OS 41.

FIG. 4C is a diagram for explaining a state of the computer 1 that is executing the processing at step S7. As shown in the figure, the rich OS 41 is present on the CPU dispatcher 44 together with the small OS 42. Not only the target application 43 but also other applications are running on the rich OS 41. Only the operation screen of the target application 43 is displayed on the display screen.

After the booting of the target application 43 ends, the CPU 2 passes, on the main memory 3, takeover data of the target application 43 on the small OS 42 to the target application 43 on the rich OS 41 (step S8). In other words, the CPU 2 passes an execution state of the target application 43 on the small OS 42 to the target application 43 on the rich OS 41. To prevent the user from recognizing that the OS on which the target application 43 is running is changed, this takeover is performed at a point when the target application 43 can safely take over a session.

After the takeover of the execution state of the target application is completed, the CPU 2 sets the rich OS 41 as an execution OS and rewrites the exception vector table 421 such that an exception is notified to the rich OS 41 (step S9). Consequently, the operation of the small OS 42 and the CPU dispatcher 44 stops. In the computer 1, only the rich OS 41 operates as the OS. The user can operate the target application 43 running on the rich OS 41. The user can also operate the applications other than the target applications 43. In other words, the booting of the OS of the computer 1 is completed.

As the rewriting of the exception vector table 421, it is advisable that the small OS 42 or the rich OS 41 requests, according to an exception such as a system call, the CPU dispatcher 44 to rewrite the exception vector table 421 and the CPU dispatcher 44 rewrites the exception vector table 421. Concerning an area of the main memory 3 used by the small OS 42, the CPU 2 can add the area to a memory area usable by the rich OS 41.

FIG. 4D is a diagram for explaining a state of the computer 1 after the operating system booting method according to this embodiment is completed. As shown in the figure, the rich OS 41 is running on the hardware 11 and the target application 43 and the other applications are running on the rich OS 41. Operation screens for the target application 43 and the other applications are displayed on the display screen.

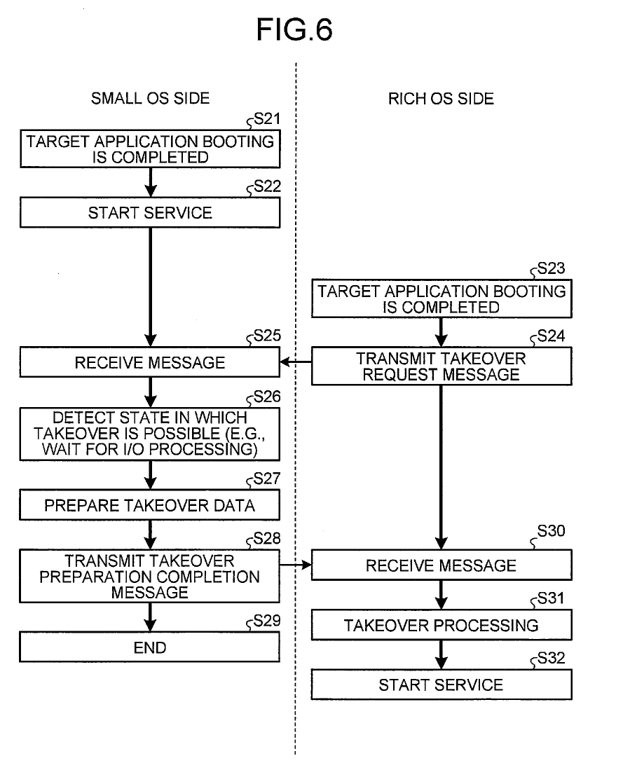

FIG. 6 is a timing chart for explaining in detail takeover of the execution state of the target application 43. As shown in the figure, first, the booting of the target application 43 on the small OS 42 at step S2 is completed (step S21) and a service for the user is started (step S22). Thereafter, after a short time, the booting of the target application 43 on the rich OS 41 at step S7 is completed (step S23). The target application 43 on the rich OS 41 transmits, by performing inter-OS communication or the like using the main memory 3, a takeover request message to the target application 43 on the small OS 42 (step S24) and waits for a takeover preparation completion message from the target application 43 on the small OS 42.

When the target application 43 on the small OS 42 receives this message (step S25), the target application 43 continues the service for the user until the target application 43 on the small OS 42 changes to a state in which takeover is possible. The state in which takeover is possible includes a state in which there is a certain length of waiting time to respond to a service request from the user (e.g., a wait for I/O processing). When the target application 43 on the small OS 42 detects this state (step S26), the target application 43 on the small OS 42 performs preparation of takeover data in addition to processing for an original service request (step S27). The target application 43 on the small OS 42 stores the takeover data on the main memory 3 such that the target application 43 on the rich OS 41 can refer to the takeover data. When the preparation of the takeover data is completed, the target application 43 on the small OS 42 transmits a takeover preparation completion message to the target application 43 on the rich OS 41 (step S28) and ends the operation of the target application 43 (step S29).

The target application 43 on the rich OS 41 receives the takeover preparation completion message (step S30). The target application 43 on the rich OS 41 sets, using the takeover data on the main memory 3, a state thereof in an execution state same as that of the target application 43 on the small OS 42 (step S31). After the exception vector table 421 is rewritten at step S9, the target application 43 on the rich OS 41 starts a service for the user (step S32). As a result, a response to the initial service request is returned to the user. However, the user does not recognize the takeover processing for the target application 43.

The CPU 2 can also boot, based on control by any program or hardware, the small OS 42, the target application 43 on the small OS 42, the CPU dispatcher 44, the rich OS 41, and the target application 43 on the rich OS 41 in the order and the timing explained above. For example, the CPU 2 can execute step S1 according to control by a boot loader program (no shown). The CPU 2 can execute steps S2 to S7 according to control by the small OS 42. The CPU 2 can execute step S8 according to control by the target application 43 on the small OS 42 and the target application 43 on the rich OS 41. The CPU 2 can execute step S9 according to control by the CPU dispatcher 44.

The CPU 2 needs to execute, in a CPU privilege mode, the booting of the CPU dispatcher 44, the rewriting of the exception vector table 421, and the booting of the rich OS 41 performed by using the CPU dispatcher 44. For example, when the small OS 42 is a Linux (registered trademark) OS, it is advisable that an image of the CPU dispatcher 44, a rewriting program for the exception vector table 421, and an image of the rich OS 41 are formed as loadable modules in advance and, when the modules are installed, preparation of an address space necessary for the booting of the CPU dispatcher 44, the rewriting of the exception vector table 421, and the load of the rich OS 41 to the address space are executed.

A technology for booting a small OS and sequentially booting additional modules to thereby make it possible to execute a large number of application groups is known. However, according to this technology, because a CPU needs to be in the CPU privilege mode during install of the additional modules, the operation of a target application is affected. On the other hand, in this embodiment, the CPU 2 only has to be in the CPU privilege mode in the booting of the CPU dispatcher 44, the booting of the rich OS 41, and the rewriting of the exception vector. Therefore, stable operation is possible compared with the method of sequentially booting the additional modules.

A technology for executing a certain OS and booting other OSs in the background of this OS is generally known as a CPU virtualization technology. However, because virtualization is always valid in the CPU virtualization technology, performance of a system is deteriorated by virtualization overhead. On the other hand, in this embodiment, it can be said that, after the small OS 42 is booted, CPU virtualization is dynamically validated to boot the rich OS 41 and, when all functions on the rich OS 41 are made usable, the CPU virtualization is dynamically invalidated. Therefore, in this embodiment, after the user is enabled to use all the functions, only the rich OS 41 is running as the execution OS. Therefore, it is possible to prevent the deterioration in performance due to the virtualization overhead.

In this embodiment, the computer programs 41 to 44 are stored in the nonvolatile memory 4 connected to the bus. However, it is also possible to store some or all of the computer programs 41 to 44 in an external storage device (not shown) or a storage device accessible from the computer 1 via a network (not shown).

In the above explanation, only one small OS 42 is booted and the rich OS 41 is booted from the small OS 42. However, it is also possible to provide a plurality of the small OSs 42.

In the above explanation, the rich OS 41 is booted from the small OS 42. However, it is also possible to boot another OS different from the rich OS 41 from the small OS 42 and boot the rich OS 41 from the booted OS.

As explained above, according to the embodiment of the present invention, the small OS 42 is booted, the target application 43 is booted on the booted small OS 42, and, after the booting of the target application 43 is completed, the CPU dispatcher 44 is booted. After the CPU dispatcher 44 is booted, by using the CPU dispatcher 44, while the booted target application 43 is caused to run on the small OS 42, the rich OS 41 is booted in the background of the small OS 42 and the target application 43 is booted on the booted rich OS 41 separately from the target application 43 running on the small OS 42. After the booting of the target application 43 on the rich OS 41 is completed, an execution state of the target application 43 running on the small OS 42 is passed to the target application 43 booted on the rich OS 41, the rich OS 41 is set as the execution OS, and the CPU dispatcher 44 is stopped. Therefore, time required for enabling the use of a target application after the start of booting of a computer is reduced as much as possible.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An operating system (OS) booting method by a CPU included in a computer, the operating system booting method comprising:
booting a small OS having a function of executing a target application;
booting the target application on the small OS, the small OS is set as an execution OS;
booting a CPU dispatcher having a function of switching the execution OS;
booting a rich OS by using the CPU dispatcher, in a background of the small OS while the target application is running on the small OS, the rich OS is capable of executing more applications than applications executed by the small OS;
booting, after the rich OS is booted, the target application on the booted rich OS separately from the target application running on the small OS; and
passing an execution state of the target application running on the small OS to the target application booted on the rich OS and shifting the execution OS from the small OS to the rich OS.

2. The operating system booting method according to claim 1, wherein the booting of the small OS is executed by expanding, on a memory, a program image of the small OS created in advance.

3. The operating system booting method according to claim 1, further comprising:
while booting the rich OS in the background of the small OS,
executing, if the small OS does not execute processing for a predetermined time while the execution OS is the small OS, first switching for switching the execution OS from the small OS to the rich OS being booted or the booted rich OS; and
executing, if an exception concerning the target application on the small OS occurs while the execution OS is the rich OS being booted or the booted rich OS, second switching for switching the execution OS from the rich OS to the small OS.

4. The operating system booting method according to claim 1, further comprising, while booting the rich OS in the background of the small OS, recording an exception state of the rich OS when an exception concerning the rich OS occurs.

5. The operating system booting method according to claim 3, further comprising:
in booting the rich OS in the background of the small OS, executing first exception vector editing for editing an exception vector table to set an entry point of the dispatcher in an exception vector;
in shifting the execution OS, executing second exception vector editing for editing the exception vector table to set an entry point of the rich OS in the exception vector; and
in executing the second switching, switching, based on the exception vector table edited by the first exception vector editing, control from the rich OS to the CPU dispatcher.

6. The operating system booting method according to claim 1, further comprising:
while shifting the execution OS from the small OS to the rich OS,
creating takeover data of the target application on the small OS; and
causing the target application on the rich OS to take over the created takeover data from the target application on the small OS.

7. The operating system booting method according to claim 6, further comprising, while shifting the execution OS from the small OS to the rich OS, transmitting a takeover request message from the target application on the rich OS to the target application on the small OS.

8. The operating system booting method according to claim 1, further comprising, while shifting the execution OS from the small OS to the rich OS, allocating a memory area, in which a program image of the small OS is stored, to a used area of the rich OS.

9. A computer comprising:
a CPU; and
a memory, wherein
the CPU boots a small OS having a function of executing a target application,
boots the target application on the small OS, the small OS is set as an execution OS and,
boots a dispatcher having a function of switching the execution OS,
boots a rich OS by using the dispatcher, in a background of the small OS, while the target application is running on the small OS, the rich OS is capable of executing more applications than applications executed by the small OS,
boots, after the rich OS is booted, the target application on the booted rich OS separately from the target application running on the small OS, and
passes an execution state of the target application running on the small OS to the target application booted on the rich OS and shifts the execution OS from the small OS to the rich OS.

10. The computer according to claim 9, wherein the CPU executes the booting of the small OS by expanding, on a memory, a program image of the small OS created in advance.

11. The computer according to claim 9, wherein
while booting the rich OS in the background of the small OS,
the CPU executes, if the small OS does not execute processing for a predetermined time while the execution OS is the small OS, first switching for switching the execution OS from the small OS to the rich OS being booted or the booted rich OS, and
executes, if an exception concerning the target application on the small OS occurs while the execution OS is the rich OS being booted or the booted rich OS, second switching for switching the execution OS from the rich OS to the small OS.

12. The computer according to claim 9, wherein, while booting the rich OS in the background of the small OS, the CPU records an exception state of the rich OS when an exception concerning the rich OS occurs.

13. The computer according to claim 11, wherein
in booting the rich OS in the background of the small OS, the CPU executes first exception vector editing for editing an exception vector table to set an entry point of the dispatcher in an exception vector,
in shifting the execution OS, the CPU executes second exception vector editing for editing the exception vector table to set an entry point of the rich OS in the exception vector, and
in executing the second switching, the CPU switchs, based on the exception vector table edited by the first exception vector editing, control from the rich OS to the CPU dispatcher.

14. The computer according to claim 9, wherein
while shifting the execution OS from the small OS to the rich OS,
the CPU creates takeover data of the target application on the small OS, and
causes the target application on the rich OS to take over the created takeover data from the target application on the small OS.

15. The computer according to claim 14, wherein, while shifting the execution OS from the small OS to the rich OS, the CPU transmits a takeover request message from the target application on the rich OS to the target application on the small OS.

16. The computer according to claim 9, wherein, while shifting the execution OS from the small OS to the rich OS, the CPU allocates a memory area, in which a program image of the small OS is stored, to a used area of the rich OS.

17. A non-transitory computer readable medium comprising instructions that cause a computer to executes switching of an execution operating system (OS) of the computer, wherein the instructions, when executed by the computer, cause the computer to perform
booting, after booting of a target application is completed on a small OS having a function of executing the target application, a rich OS for booting the target application separately from the target application running on the small OS, the rich OS being capable of executing more applications than applications executed by the small OS;
switching, when an execution OS is the rich OS being booted or the booted rich OS and an exception concerning the target application occurs, the execution OS from the rich OS to the small OS; and
switching, when the execution OS is the small OS and the small OS does not execute processing for a predetermined time, the execution OS from the small OS to the rich OS being booted or the booted rich OS.
